(19) United States
(12) Patent Application Publication
(10) Pub. No.: US 2003/0080283 A1
(43) Pub. Date: May 1, 2003

(54) Clamping apparatus with optical detectors

(76) Inventor: Luciano Migliori, Milan (IT)

Correspondence Address: YOUNG & THOMPSON, 745 SOUTH 23RD STREET 2ND FLOOR, ARLINGTON, VA, 22202

(21) Appl. No.: 10/269,061

(22) Filed: Oct. 11, 2002

(30) Foreign Application Priority Data
Oct. 25, 2001 (IT) MI2001A 002240

(51) Int. Cl. G06M 7/00

(52) U.S. Cl. 250/221

(57) ABSTRACT

The clamping apparatus for clamping work-pieces, is provided with optical detectors for sensing and/or controlling a movable member at the ends of a stroke. The working positions of the movable member are sensed by optical detectors removably supported and positionably housed in a front open casing fitted in the body of the apparatus. In the event the clamping apparatus being operated by a rotary actuator, use is made of an optical detector of rotary type to provide a set of control signals.

### BACKGROUND OF THE INVENTION

This invention refers to a toggle-lever clamping apparatus for clamping work-pieces, and more particularly is directed to a pneumatically, hydraulically or electrically operated clamping apparatus provided with a particular mounting support for optical detectors suitable for detecting and controlling the working positions of a clamping arm.

### STATE OF THE ART

In numerous industrial sectors, in particular in the automotive or motor vehicle manufacturing field, use is made of special clamping apparatus for holding work-pieces which are to be assembled, welded or subjected to various processing operations.

Devices of this kind generally comprise a pivotable clamping arm connected, by means of a toggle-lever mechanism, to a linearly movable control member, such as the piston rod of a cylinder or a pushing member connected to the toggle leverage operating the clamping apparatus.

Toggle-lever clamping apparatus are described for example in EP 0 962 285, EP 0 636 449 and EP 0 911 112; therefore reference is made to said documents to illustrate the features and the working of said devices.

In general, a device of the aforementioned kind substantially comprises a pivotable clamping arm connected, by means of a toggle-lever mechanism, to the rod or to a pushing member of a linear actuator, such as a pneumatic cylinder which controls the reciprocating movement of a clamping arm between a forward or first stop position, and a backward or second stop position.

Devices of this kind are used in complex systems for assembling panels or structural parts of motor vehicles in the automotive industry, which call for secure and perfectly controlled clamping actions, which must be operated according to determined work schedules.

In clamping systems of the aforementioned kind, it is necessary to control the working and stop positions of the clamping arm with the utmost precision, and to provide specific control units which govern the entire working cycle with suitable positioning and consent signals.

In order to achieve the necessary sensing and detection of the position of the clamping arm, and control operations, various detectors of inductive type, electric or pneumatic micro-switches appropriately preset for sensing the end of the stroke of the actuator, or of a movable member associated with the latter, have been largely proposed and used.

However, position sensing and control systems which make use of inductive detectors or micro-switches present a number of defects and inconveniences.

In particular, this type of detectors do not afford extremely precise sensing and control, due both to the intrinsic features of the detectors themselves, and due to external factors which are capable of affecting their intervention and transmission of the control signals.

In particular, detectors of inductive type are seriously affected by the presence of external magnetic fields, or by the metallic masses which are generally located closely to the same detectors; moreover, in addition to being affected by external factors, the field of activation of an inductive detector may vary according to its structural features.

In turn, the use of electric or pneumatic micro-switches does not afford a satisfactory degree of sensing and constancy over time, in that, as a result of their repeated and continuous operation, they are subject to wear or to the infiltration of dirt which jeopardises their working condition.

Lastly, detectors of inductive type or micro-switches are designed to be used exclusively on clamping apparatus comprising a linear type of actuator, to provide only a position verification.

Under no circumstances are these types of detectors used or usable with electric actuators of rotary type, or whenever it is necessary to emit a sequence of control signals capable of continuously checking or controlling a linearly movable member between two end positions of a working stroke, as well as intermediate positions, without having to resort to complex and expensive solutions.

Today, photo-interrupters or photo-sensing devices are largely used in many applications for detecting and/or controlling the position of objects, in light barriers, or for digital counting operations.

Usually photo interrupters are comprised of a light emitting element and a light receiving element facing each others in a light transmission path. If a flag or an object is inserted or passing through the light emitting and light receiving elements, the optical transmission path will be interrupted providing an electrical signal to a control unit.

Examples of photo-interrupters or photo-sensing devices are known, for example, by EP 0 484 877, U.S. Pat. No. 5,567,953 and U.S. Pat. No. 6,403,951.

In particular, U.S. Pat. No. 6,403,951, which constitute the prior art closer to the present invention, describes an optical detection module for a holding or gripping device, comprising a body having a slot permitting the passage of a target or flag operatively connected to a movable member to be detected; the detection module comprises a casing provided with an optical detector at both ends, in which each optical detector comprises a light emitter and a light receiver spaced apart by a transmission width, and in which the body of the clamping apparatus comprises a slot for the passage of the target of flag, which is narrower than said light transmission width of the optical detectors.

Although the use of optical detectors for holding or gripping device is suggested in U.S. Pat. No. 6,403,951, their use suffers again of some troubles or cumbersome.

In particular, the optical transmission detectors are fixedly spaced apart on an outer surface of the detection module, without any possibility to change their positions, or to remove and/or substitute the same detectors according to occurrences; therefore the disposition of the detectors must be suitably decided in advance during designing of the clamping apparatus.

Furthermore, no possibility exists to modify the module, for example to add further optical detectors during or after the assembling, for example for changing the stop positions of the same detectors, or to provide control signals in advance the gripping device will reach the ends of its working stroke.

### OBJECTS OF THE INVENTION

The main object of this invention is to provide a clamping apparatus for clamping work-pieces, provided with a sensing and/or control device for detecting and/or controlling the working positions of a movable member of the same clamping apparatus, whereby it is possible to sense with the utmost precision, extreme and/or intermediate working positions, in order to adapt the use of the clamping apparatus to different operative conditions and/or management of its operative cycle.

A still further object of this invention is to provide a detection device for sensing and controlling the working positions of a holding or gripping device, whereby it is possible to change the sensing positions of the detectors, as well as to manage a control in an extremely practical way, by simply modifying the position of the detectors without having to modify the same detection device, and the same clamping apparatus, and avoiding to directly acting on the electronic unit which controls the management and operation of the same clamping apparatus.

### BRIEF DESCRIPTION OF THE INVENTION

All the above can be achieved by means of a clamping apparatus, particularly suitable for holding or clamping motor vehicle panels or iron sheets in automotive assembling plants, which contemplates the use of a detection device for controlling and sensing the ends and/or intermediate working positions of the same clamping apparatus, by means of optical detectors of such kind as not to be affected by external events.

More in particular, according to the invention, there is provided a clamping apparatus for clamping a work-piece, provided with a detection device for controlling and/or sensing working positions of a movable member, the clamping apparatus comprising:

a box-shaped support head;

a clamping member pivotally mounted on the support head to rotate between a first and a second position of a working stroke, to release respectively to lock said work-piece;

an actuator having an axially movable pushing member operatively connected to the clamping member by a toggle-lever mechanism; and

optical detection means for detecting at least a working position of the clamping member along said working stroke;

wherein said optical detection means comprises:

a front open casing longitudinally extending to clamping apparatus;

at least one optical detector removably fitted into said front open casing, said optical detector having spaced apart light emitting and light receiving elements protruding from the casing; and

means on said optical detector and casing for selectively positioning the optical detector into the casing of said optical detection means.

According to a first aspect of the invention, the optical detector comprises:

a casing having bottom and side walls;

an open end hollow body for housing an optical detector, said body having side walls slidably fitted between corresponding side walls of the casing; and

a rib on opposite side walls of the hollow body, to selectively engage with a plurality of spaced apart slots on the side walls of the casing, said slots defining different working positions for an optical detector of said optical detection means.

According to a further aspect of the invention, in which the clamping apparatus is provided with a pneumatic or hydraulic actuator, first and second optical detectors are slidably housed in a box shaped casing having side walls longitudinally extending at one side of pushing member of the clamping apparatus, thereby making it possible to change the position of one or both of the detectors, according the working requirements, by merely threading the detectors into an open side of the casing, at differently spaced apart positions on said side walls.

According to another feature of the invention, in which the clamping apparatus is provided with an electric actuator connected to a rotatable and axially extendable control shaft, the optical detection means comprises an optical detector provided with a light emitting and light receiving element, and a dish or cup shaped shattering member, having a plurality of passing through apertures for the light to repeatedly provide a set of control signals to an electronic control unit, during extension and shortening of the control shaft.

### BRIEF DESCRIPTION OF THE DRAWINGS

These and further features of a clamping apparatus provided with an optical detectors, according to this invention, will be more clearly evident from the following description with reference to the accompanying drawings, in which:

FIG. 1 shows the diagram of a first embodiment of a clamping apparatus operated by a pneumatic cylinder, with an optical detection device according to this invention;

FIG. 2 shows a perspective view of the casing for the optical detectors;

FIG. 3 shows a perspective view of an optical detector;

FIG. 4 shows an enlarged sectional view of the casing of FIG. 3, fitted into the body of the clamping apparatus of FIG. 1;

FIG. 5 shows a cross sectional view along the line 5-5 of FIG. 4;

FIG. 6 shows a second embodiment of a clamping apparatus operated by an electric motor, with an optical detection device, according to this invention.

### DETAILED DESCRIPTION OF THE INVENTION

With reference to the figures from 1 to 4, a description will be given of the general features and a particular embodiment of a clamping apparatus provided with an optical detection device for controlling the positions of a movable clamping arm, according to this invention.

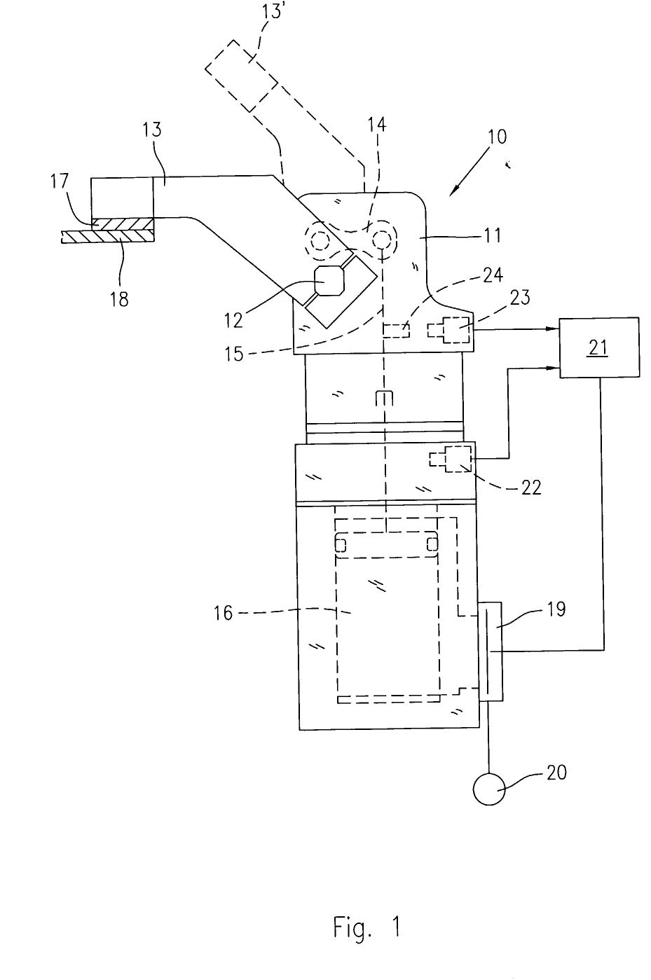

In FIG. 1, reference 10 indicates, as a whole, a lever-operated clamping apparatus, normally used for clamping panels, iron sheets or components of motor vehicles under construction; the device 10 comprises a head 11 having a box shaped body onto which a clamping arm 13 is pivoted in 12, to rotate between two end working positions.

In a per se known way, the clamping arm 13 is connected, by means of a toggle lever mechanism 14, to an axially-sliding pushing member 15, which in turn is connected to or forms part of the piston rod of a hydraulic or pneumatic control cylinder 16, or to other type of linear actuator, to move in a controlled way the member 15 and, consequently, the clamping arm 13, between two end positions along a working stroke; that is to say, between a rearward position of the pushing member 15, in which the clamping arm is in an open position 13′, FIG. 1, in which it releases the work-piece 17, and a forward rotated position in which said arm 13 is in a closed position for clamping the work-piece 17, by exerting the necessary pressure against a resting surface 18.

Reference 19 in FIG. 1 indicates a set of solenoid valves controlled by a central processing unit 21, to connect the actuator cylinder 16 to a pressure fluid source 20, for example pressurised air, to move the arm 13 between the open and the closed condition, according to a specific working programme managed by the processing unit 21.

As mentioned previously, in the clamping apparatus of the above mentioned type, at each working operation it is necessary to carry out a position checking operation, or control in correspondence with the bottom dead centre of the toggle mechanism, when the clamping apparatus is open, and in correspondence with the top dead centre, when the clamping apparatus is the closed condition, to supply the electronic control unit 21 with control signals indicative of the “open” and “closed” condition of the same clamping apparatus, and with a starting signal to carry out the required operations on the work-piece 17.

As mentioned previously, in the previously known clamping apparatus, use is made of inductive, electromechanical or pneumatic type position sensors with consequent problems with regard to the reliability of the system due to the previously mentioned reasons.

According to this invention use is made of an optical detection device in that it is not affected by external factors and in that it can be easily positioned inside the head 11 of the clamping apparatus, being also capable of providing both position detecting signals, and a set of control signals, by means of structurally simple and economical solutions.

More precisely, as shown in FIG. 1, use is made of a first optical detector 22 for revealing the closed position of the clamping arm 13, corresponding to the lower end of its working stroke, and a second optical detector 23 for revealing the open position corresponding to the upper end of stroke.

The digital signals emitted by the two optical detectors 22 and 23, are transmitted to corresponding inlets of the electronic control unit 21, for processing, which is suitably programmed or programmable for managing a given work cycle of the clamping apparatus.

The activation of the optical detectors 22 and 23 can be carried out in any appropriate way, for example by providing the control rod 15 with a flag 24 designed to interrupt the light beam between the transmitter and the receiver of the detectors, as explained further on with reference to the remaining figures from 2 to 4.

It was pointed out previously that the two optical detectors 22 and 23 are positioned inside the box shaped body of the head 11, in correspondence with both ends of the stroke, thereby being fully protected against the external environment.

However, depending upon specific operative requirements, it may sometimes be necessary to vary the position of one or both of the optical detectors 22 and 23.

According to one aspect of this invention, the above requirement has been solved by simply using a front open casing for housing the detectors 22 and 23, and by providing the optical detectors with an open end support body.

As shown in the figures from 2 to 4, the casing for housing the optical detectors 22 and 23 is indicated as a whole by reference 25, and is shaped so as to fit tightly into a corresponding seat in the head body 11 of the clamping apparatus 10, in such a way as to allow a quick insertion, removal and repositioning of one or both of the optical detectors in a plurality of positions in the casing 25 aligned in a direction parallel to the longitudinal moving direction of the control rod 15, or equivalent member of the actuator.

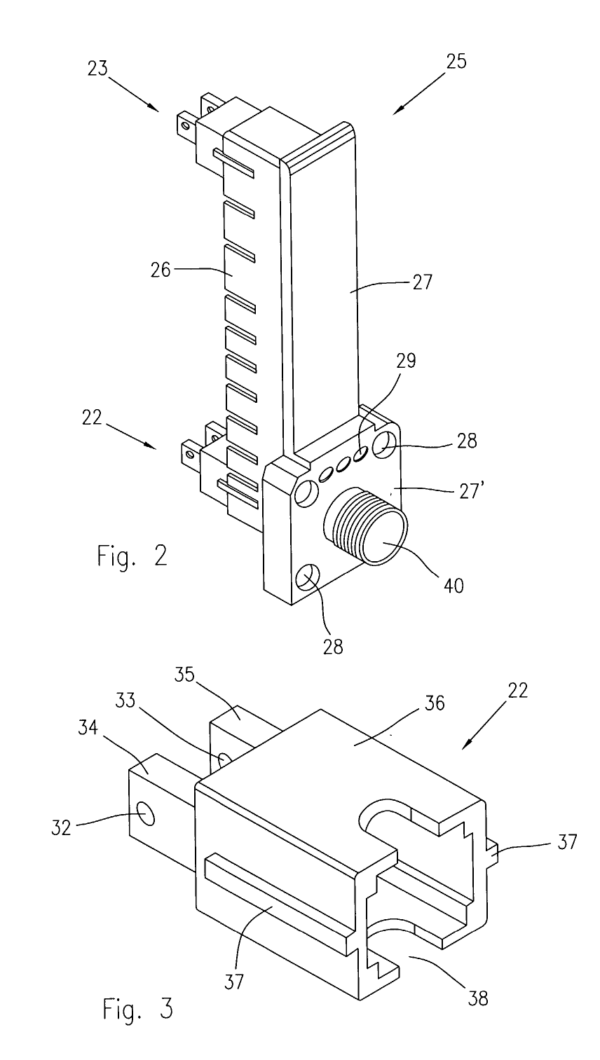

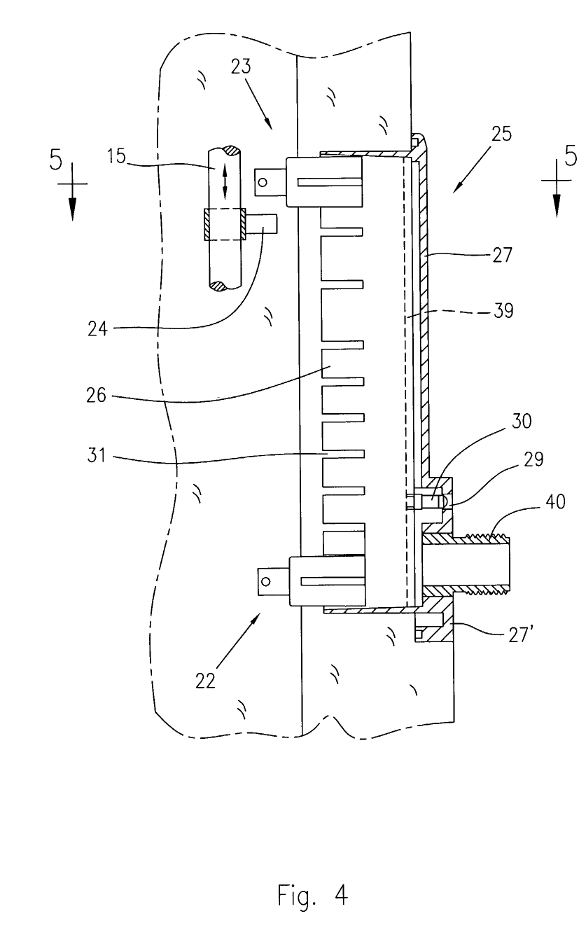

Consequently, as shown in FIGS. 2 and 4, the casing 25 is provided with lateral walls 26 which extend from a rear wall 27 provided with a widened portion 27′ having holes 28 for the passage of fastening screws; holes 29 allow light emitting diodes 30 (LEDs) to be visible to provide light signals relating to specific operative conditions of the clamping apparatus.

As is also shown in FIG. 2, and in the enlarged cross sectional view in FIG. 4, both of the lateral walls 26 of the casing 25 for the optical detectors, are provided with a plurality of transversal slots 31 to removably retain the optical detectors 22 and 23, as explained further on.

Depending on requirements, or the type of clamping apparatus, the slots 31 can be disposed either at a regular space or at a variable distance from one another, for example, progressively increasing from one end of the casing 25, in relation to the movement and opening angle required for the clamping arm 13.

The insertion and removal of each optical detector 22, 23 in the casing 25, according to that shown in FIGS. 2 and 3, is carried out by means of a sliding connection.

FIGS. 3 and 4 of the accompanying drawings show a particular embodiment, for example for the optical detector 22, and the relevant means for coupling it with the casing 25 and with the head body 11 of the clamping apparatus.

In this connection, each optical detector comprises a light emitter 32 and a light receiver 33 housed in a respective arm 34, 35 of a fork shaped detector, which extends from one end of an hollow support body 36; the body 36 is suitably provided with open ends and is box-shaped so as to fit between the lateral walls 26 of the casing 25, and to contain a base having the electric terminals for connection of the detector to an electronic card and for converting the light signals into digital electric signals, in a per se known mode.

The two arms 34 and 35 for supporting the emitter 32 and the receiver 33 of each optical detector, are appropriately spaced apart from each other to allow the passage of the flag 24 connected to the control rod 15, for intercepting the light beam.

The box-shaped body 36 of the detector, as shown in FIG. 3, is delimited by flat side surfaces, two of which are provided with a longitudinal outer rib 37 designed to fit into the transversal slots 31 in the lateral walls of the casing 25 for the optical detectors 22, 23; the two remaining side walls of the box-shaped body 36, at the opposite end, are provided with a wide U-shaped aperture 28 for the passage of the electrical conductors for connection to an electronic card 39 housed at the bottom of the casing 25, against the rear wall 27, which, as mentioned previously, supplies power to the LEDs 30, and to the detectors 22, 23 to convert the electric signals into digital form.

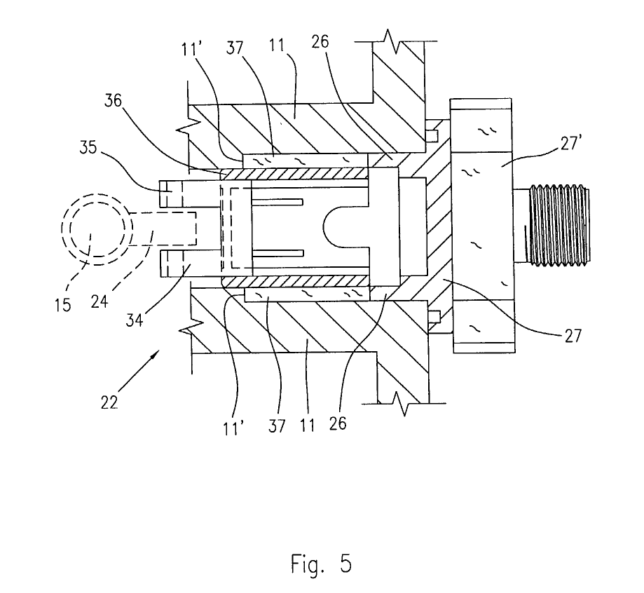

According to a further feature shown in FIG. 5, in order to secure the box-shaped body of the two detectors 22, 23 to the casing 25 seated into the head 11, the opposite edges of each slot have been provided with inside shoulder surfaces 11′, against which the two outer ribs 37 of the box-shaped body 36 of the detectors come to rest.

Lastly, from FIGS. 2 and 4 it can be seen that the portion 27′ of the casing 25 for the optical detectors, is provided with a threaded bush 40 for the passage of the electrical conductors.

In the case of FIG. 1, that is to say, in the case of the clamping apparatus 10 comprising a pneumatic or linear-type actuator, both the optical detectors 22 and 23 are housed and positioned in the casing 25, in correspondence with the top and bottom dead centres of the toggle-lever mechanism 14, at the end of the stroke of the control rod 15 or of the respective actuator.

According to this solution, the optical detectors 22 and 23 provide signals for checking a position only, transmitted to the central processing unit 21 which controls and manages the working operation of an entire system including a plurality of clamping apparatus; in this case, for example, in order to be able to sense or detect a different angle of aperture of the clamping arm 13, it is necessary to remove the optical detector 22 from the casing 25 and to introduce the same detector in a different position from the previous one.

This can be done by simply inserting the optical detector 22 in the appropriate position in the casing 25, by threading the ribs 37 of the box-shaped support body 36, into a different pair of slots 31 in the side walls 26 of the casing 25.

This operation can be carried out with the utmost simplicity, by removing the casing 25 from the head body 11 and then re-inserting it after having moved the optical detector in a new position.

In certain cases it is also necessary to carry out a position control during the operative cycle of each clamping apparatus, singly and independently of the other clamping apparatus belonging to a same system.

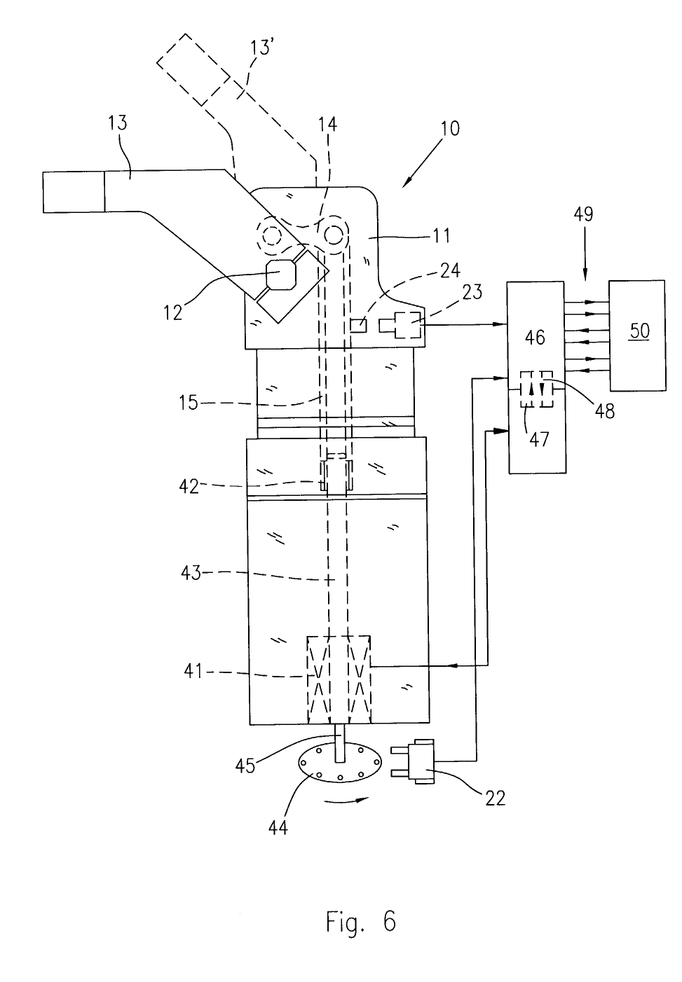

A clamping apparatus suitable for this specific purpose is shown in FIG. 6 of the accompanying drawings.

In FIG. 6 the same numerical references as FIG. 1 have been used to indicate similar or equivalent parts. Therefore, also in FIG. 6 the clamping apparatus 10 comprises a head body 11 having a clamping arm 13 pivoted at 12.

The arm 13 is in turn connected, by means of the toggle-lever mechanism 14, to an axially movable pushing member or control rod 15, which is operatively connected to an electric actuator comprising at least one electric motor 41.

In this connection, secured to the rear end of a screw rod 15, is a screw nut 42 capable of sliding movement along a screw shaft 43 connected to or forming part of the shaft of an electric motor 41; consequently, the rotation of the screw shaft 43, is transformed into a corresponding axial displacement of the nut screw 42 and of the control rod 15, resulting in an angular movement of the clamping arm 13.

Similarly to the example of FIG. 1, also in the case of FIG. 6 the optical detector 23 relating to the end of stroke corresponding to the top dead centre, is inserted in a casing 25 as described previously, to provide a signal for detecting the position reached by the rod 15, that is to say, the closure of the clamping arm 13 to lock a work-piece.

Conversely, the optical detector 22 in this case is differently conformed and positioned to provide a set of control signals, during closure and opening of the clamping arm 13.

In this connection, the optical detector 22 is positioned below the clamping apparatus, and comprises a disk or cup-shaped shuttering member 44, suitably perforated or slotted along the peripheral edge to continuously intercept the light beam of the detector 22, directly or indirectly connected to the shaft of the electric motor, for example to an extension 45 of the latter, as shown.

Lastly, from the FIG. 6, it can be seen that the two optical detectors 22, 23 are connected to the data inlets inputs of a electronic control unit 46, comprising a power block 47 for operating the electric motor, and a safety block 48 to provide the local control unit 46 with safety signals derived from a change in the operative conditions of the circuit 47 supplying power to the electric motor, when the clamping arm 13 of the device 10, encounters an obstacle; the system is capable of halting or reversing the rotation.

The local control unit 46 of each clamping apparatus belonging to a complex system, is in turn connected, by means of appropriate conductors 49, to a central unit 50 which manages and controls the entire system.

From what has been described and shown in the accompanying drawings, it will be clear that according to the invention what is provided is a clamping apparatus for clamping work-pieces which, contrary to all the previous tendencies, advantageously makes use of optical control sensors providing an extremely simple solution whereby it is possible to supply position detection signals, and position control signals, and to easily adapt the same device to different operating requirements.

It is understood that what has been described and shown with reference to the accompanying drawings, has been given purely by way of example in order to illustrate the general features and some particular embodiments; consequently, other modifications or variations may be made to the shape and structure of the clamping apparatus, or of the electronic control units, without departing from the scope of the claims.

What we claim is:

1. Clamping apparatus for clamping a work-piece, of the type comprising:
a box-shaped support head;
a clamping member pivotally mounted on the support head to rotate between a first and a second position of a working stroke, to release respectively to lock said work-piece;
an actuator having an axially movable pushing member operatively connected to the clamping member by a toggle-lever mechanism; and
optical detection means for detecting at least a working position of the clamping member along said working stroke;
wherein said optical detection means comprises:
a front open casing longitudinally extending to clamping apparatus;
at least one optical detector removably fitted into said front open casing, said optical detector having spaced apart light emitting and light receiving elements protruding from the casing; and
means on said optical detector and casing for selectively positioning the optical detector into the casing of said optical detection means.

2. Clamping apparatus according to claim 1, wherein said optical detector comprises:
a front open casing for housing the optical detector, having lateral walls provided with a plurality of transversal slots;
the optical detector comprising an open-end hollow body having side walls provided with longitudinal ribs insertable into the slots of the walls of the casing, to rest against shoulder surfaces of the support head.

3. Clamping apparatus according to claim 1, wherein an electronic card for supplying power to the detector, and for conversion of the electrical signals, is housed at the bottom of the casing for the optical detector.

4. Clamping apparatus according to claim 2, wherein the slots in the lateral walls of the casing, are disposed each other at a regular space.

5. Clamping apparatus according to claim 2, wherein the slots in the lateral walls of the casing, are disposed each other at variable space.

6. Clamping apparatus according to claim 1, wherein said pushing member is operatively connected to a rotary type actuator, having a rotating shaft, wherein an optical detector is disposed close to one end of the rotating shaft, and a shuttering member operatively connected to the rotating shaft, said shuttering member being provided with a plurality of peripheral apertures for repeatedly intercepting the light beam of the optical detector, and circuit means for converting the optical signals in electrical signals fed to an electronic control unit.

7. Clamping apparatus according to claim 7, wherein said rotary actuator is consisting in at least one electric motor.
